(19) United States
(12) Patent Application Publication
(10) Pub. No.: US 2023/0265350 A1
(43) Pub. Date: Aug. 24, 2023

(54) PROCESS AND SYSTEM FOR BASE OIL PRODUCTION USING BIMETALLIC SSZ-91 CATALYST

(71) Applicant: CHEVRON U.S.A. INC., San Ramon, CA (US)

(72) Inventors: Yihua ZHANG, Albany, CA (US); Adeola OJO, Pleasant Hill, CA (US); Guan-Dao LEI, Walnut Creek, CA (US)

(21) Appl. No.: 18/043,738

(22) PCT Filed: Sep. 3, 2021
(86) PCT No.: PCT/US21/48992

§ 371 Date: Mar. 2, 2023

Related U.S. Application Data
(60) Provisional application No. 63/074,212, filed on Sep. 3, 2020.

(51) Int. Cl. C10G 45/64; B01J 37/00; C10G 45/62; B01J 29/70; B01J 29/068; B01J 29/072

(52) U.S. Cl. CPC C10G 45/64; B01J 37/0009; C10G 45/62; B01J 29/703; B01J 29/7023; B01J 29/068; B01J 29/072

(57) ABSTRACT

An improved process and catalyst system for making a base oil product and for reducing base oil aromatics content, while also providing good product yields. The process and catalyst system generally involves the use of a bimetallic SSZ-91 catalyst by contacting the catalyst with a hydrocarbon feedstock to provide dewaxed base oil products.

### CROSS REFERENCE TO RELATED APPLICATIONS

This application is the national stage application of International Appl. No. PCT/US2021/048992 (doc. no. T-11141), filed on 3 Sep. 2021, and is related to, and claims the benefit of priority to U.S. Provisional Patent Appl. Ser. No. 63/074,212 filed on 3 Sep. 2020, entitled “PROCESS AND SYSTEM FOR BASE OIL PRODUCTION USING BIMETALLIC SSZ-91 CATALYST”, the disclosures of which are herein incorporated in their entirety.

### FIELD OF THE INVENTION

A process and system for producing base oils from hydrocarbon feedstocks using a bimetallic SSZ-91 catalyst.

### BACKGROUND OF THE INVENTION

A hydroisomerization catalytic dewaxing process for the production of base oils from a hydrocarbon feedstock involves introducing the feed into a reactor containing a dewaxing catalyst system with the presence of hydrogen. Within the reactor, the feed contacts the hydroisomerization catalyst under hydroisomerization dewaxing conditions to provide an isomerized stream. Hydroisomerization removes aromatics and residual nitrogen and sulfur and isomerize the normal paraffins to improve the cold flow properties. The isomerized stream may be further contacted in a second reactor with a hydrofinishing catalyst to remove traces of any aromatics, olefins, improve color, and the like from the base oil product. The hydrofinishing unit may include a hydrofinishing catalyst comprising an alumina support and a noble metal, typically palladium, or platinum in combination with palladium.

The challenges generally faced in typical hydroisomerization catalytic dewaxing processes include, among others, providing product(s) that meet pertinent product specifications, such as cloud point, pour point, viscosity and/or viscosity index limits for one or more products, while also maintaining good product yield. In addition, further upgrading, e.g., during hydrofinishing, to further improve product quality may be used, e.g., for color and oxidation stability by saturating aromatics to reduce the aromatics content. The presence of residual organic sulfur and nitrogen from upstream hydrotreatment and hydrocracking processes, however, may have a significant impact on downstream processes and final base oil product quality. A more robust catalyst for base oil production is therefore needed to isomerize wax molecules and convert aromatics to saturated species. Accordingly, a need exists for processes and catalyst systems to produce base oil products having reduced aromatics content, while also providing good product yield.

### SUMMARY OF THE INVENTION

This invention relates to processes and catalyst systems for converting wax-containing hydrocarbon feedstocks into high-grade products, including base oils generally having a reduced aromatics content. Such processes employ a bimetallic catalyst system comprising a bimetallic SSZ-91 hydroisomerization dewaxing catalyst. The hydroisomerization process converts aliphatic, unbranched paraffinic hydrocarbons (n-paraffins) to isoparaffins and cyclic species, thereby decreasing the pour point and cloud point of the base oil product as compared with the feedstock. Bimetallic SSZ-91 catalysts have been found to advantageously provide base oil products having a reduced aromatics content as compared with base oil products produced using non-bimetallic catalysts.

In one aspect, the present invention is directed to a hydroisomerization process, which is useful to make dewaxed products including base oils, particularly base oil products of one or more product grades through hydroprocessing of a suitable hydrocarbon feedstream. While not necessarily limited thereto, one of the goals of the invention is to provide reduced aromatics content in base oil products while also providing good base oil product yields.

The process generally comprises contacting a hydrocarbon feed with a hydroisomerization catalyst under hydroisomerization conditions to produce a product or product stream; wherein, the hydroisomerization catalyst comprises a bimetallic SSZ-91 molecular sieve comprising at least two different modifying metals selected from Groups 7 to 10 and 14 of the Periodic Table.

The invention is also directed to a hydroisomerization catalyst system comprising the bimetallic SSZ-91 hydroisomerization catalyst used in the process described herein.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“API gravity” refers to the gravity of a petroleum feedstock or product relative to water, as determined by ASTM D4052-11.

“Viscosity index” (VI) represents the temperature dependency of a lubricant, as determined by ASTM D2270-10(E2011).

“Vacuum gas oil” (VGO) is a byproduct of crude oil vacuum distillation that can be sent to a hydroprocessing unit or to an aromatic extraction for upgrading into base oils. VGO generally comprises hydrocarbons with a boiling range distribution between 343° C. (649° F.) and 593° C. (1100° F.) at 0.101 MPa.

“Treatment,” “treated,” “upgrade,” “upgrading” and “upgraded,” when used in conjunction with an oil feedstock, describes a feedstock that is being or has been subjected to hydroprocessing, or a resulting material or crude product, having a reduction in the molecular weight of the feedstock, a reduction in the boiling point range of the feedstock, a reduction in the concentration of asphaltenes, a reduction in the concentration of hydrocarbon free radicals, and/or a reduction in the quantity of impurities, such as sulfur, nitrogen, oxygen, halides, and metals.

“Hydroprocessing” refers to a process in which a carbonaceous feedstock is brought into contact with hydrogen and a catalyst, at a higher temperature and pressure, for the purpose of removing undesirable impurities and/or converting the feedstock to a desired product. Examples of hydroprocessing processes include hydrocracking, hydrotreating, catalytic dewaxing, and hydrofinishing.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

“Hydrotreating” refers to a process that converts sulfur and/or nitrogen-containing hydrocarbon feeds into hydrocarbon products with reduced sulfur and/or nitrogen content, typically in conjunction with hydrocracking, and which generates hydrogen sulfide and/or ammonia (respectively) as byproducts. Such processes or steps performed in the presence of hydrogen include hydrodesulfurization, hydrodenitrogenation, hydrodemetallation, and/or hydrodearomatization of components (e.g., impurities) of a hydrocarbon feedstock, and/or for the hydrogenation of unsaturated compounds in the feedstock. Depending on the type of hydrotreating and the reaction conditions, products of hydrotreating processes may have improved viscosities, viscosity indices, saturates content, low temperature properties, volatilities and depolarization, for example. The terms “guard layer” and “guard bed” may be used herein synonymously and interchangeably to refer to a hydrotreating catalyst or hydrotreating catalyst layer. The guard layer may be a component of a catalyst system for hydrocarbon dewaxing, and may be disposed upstream from at least one hydroisomerization catalyst.

“Catalytic dewaxing”, or hydroisomerization, refers to a process in which normal paraffins are isomerized to their more branched counterparts by contact with a catalyst in the presence of hydrogen.

“Hydrofinishing” refers to a process that is intended to improve the oxidation stability, UV stability, and appearance of the hydrofinished product by removing traces of aromatics, olefins, color bodies, and solvents. UV stability refers to the stability of the hydrocarbon being tested when exposed to UV light and oxygen. Instability is indicated when a visible precipitate forms, usually seen as Hoc or cloudiness, or a darker color develops upon exposure to ultraviolet light and air. A general description of hydrofinishing may be found in U.S. Pat. Nos. 3,852,207 and 4,673,487.

The term “Hydrogen” or “hydrogen” refers to hydrogen itself, and/or a compound or compounds that provide a source of hydrogen.

“Aromatics content” refers to the aromatics content in the dewaxed product, with the conversion of aromatics (X) calculated by the following formula:

X=(C_{feed}−C_{product})/C_{feed}*100

where C_{feed} and C_{product} are the aromatics content in the feed and product.

“Cut point” refers to the temperature on a True Boiling Point (TBP) curve at which a predetermined degree of separation is reached.

“Pour point” refers to the temperature at which an oil will begin to flow under controlled conditions. The pour point may be determined by, for example, ASTM D5950.

“Cloud point” refers to the temperature at which a lube base oil sample begins to develop a haze as the oil is cooled under specified conditions. The cloud point of a lube base oil is complementary to its pour point. Cloud point may be determined by, for example, ASTM D5773.

“TBP” refers to the boiling point of a hydrocarbonaceous feed or product, as determined by Simulated Distillation (SimDist) by ASTM D2887-13.

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

The term “Periodic Table” refers to the version of the IUPAC Periodic Table of the Elements dated Jun. 22, 2007, and the numbering scheme for the Periodic Table Groups is as described in Chem. Eng. News, 63(5), 26-27 (1985). “Group 2” refers to IUPAC Group 2 elements, e.g., magnesium, (Mg), Calcium (Ca), Strontium (Sr), Barium (Ba) and combinations thereof in any of elemental, compound, or ionic form. “Group 7” refers to IUPAC Group 7 elements, e.g., manganese (Mn), rhenium (Re) and combinations thereof in their elemental, compound, or ionic form. “Group 8” refers to IUPAC Group 8 elements, e.g., iron (Fe), ruthenium (Ru), osmium (Os) and combinations thereof in their elemental, compound, or ionic form. “Group 9” refers to IUPAC Group 9 elements, e.g., cobalt (Co), rhodium (Rh), iridium (Ir) and combinations thereof in any of elemental, compound, or ionic form. “Group 10” refers to IUPAC Group 10 elements, e.g., nickel (Ni), palladium (Pd), platinum (Pt) and combinations thereof in any of elemental, compound, or ionic form. “Group 14” refers to IUPAC Group 14 elements, e.g., germanium (Ge), tin (Sn), lead (Pb) and combinations thereof in any of elemental, compound, or ionic form.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. The term “molecular sieve” and “zeolite” are synonymous and include (a) intermediate and (b) final or target molecular sieves and molecular sieves produced by (1) direct synthesis or (2) post-crystallization treatment (secondary modification). Secondary synthesis techniques allow for the synthesis of a target material from an intermediate material by heteroatom lattice substitution or other techniques. For example, an aluminosilicate can be synthesized from an intermediate borosilicate by post-crystallization heteroatom lattice substitution of the Al for B. Such techniques are known, for example as described in U.S. Pat. No. 6,790,433. Zeolites, crystalline aluminophosphates and crystalline silicoaluminophosphates are representative examples of molecular sieves.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

In one aspect, the present invention is a hydroisomerization process, useful to make dewaxed products including base oils, the process comprising contacting a hydrocarbon feed with a hydroisomerization catalyst under hydroisomerization conditions to produce a product or product stream; wherein, the hydroisomerization catalyst comprises a bimetallic SSZ-91 molecular sieve comprising at least two modifying metals selected from Groups 7 to 10 and 14 of the Periodic Table.

The SSZ-91 molecular sieve used in the hydroisomerization catalyst is described in, e.g., U.S. Pat. Nos. 9,802,830; 9,920,260; 10,618,816; and in WO2017/034823. The SSZ-91 molecular sieve generally comprises ZSM-48 type zeolite material, the molecular sieve having at least 70% polytype 6 of the total ZSM-48-type material; an EUO-type phase in an amount of between 0 and 3.5 percent by weight; and polycrystalline aggregate morphology comprising crystallites having an average aspect ratio of between 1 and 8. The silicon oxide to aluminum oxide mole ratio of the SSZ-91 molecular sieve may be in the range of 40 to 220 or 50 to 220 or 40 to 200. The foregoing noted patents provide additional details concerning SSZ-91 sieves, methods for their preparation, and catalysts formed therefrom.

The bimetallic SSZ-91 catalyst may advantageously comprise a first Group 10 metal and, optionally, a second metal selected from Groups 7 to 10 and Group 14 metals of the Periodic Table. The Group 10 metal may be, e.g., platinum, palladium or a combination thereof, and optionally with a Group 2 metal. Platinum is a suitable Group 10 metal along with another Groups 7 to 10 and Group 14 metal in some aspects. While not limited thereto, the Groups 7 to 10 and Group 14 metal may be more narrowly selected from Pt, Pd, Ni, Re, Ru, Ir, Sn, or a combination thereof. In conjunction with Pt as a first metal in the SSZ-91 catalyst, the second metal in the bimetallic SSZ-91 catalyst may also be more narrowly selected from the second Groups 7 to 10 and Group 14 metal is selected from Pd, Ni, Re, Ru, Ir, Sn, or a combination thereof. In a more specific instance, the bimetallic SSZ-91 catalyst may comprise Pt as a Group 10 metal in an amount of 0.01-5.0 wt. % or 0.01-2.0 wt. %, or 0.1-2.0 wt. %, more particularly 0.01-1.0 wt. % and 0.01-1.5 wt. % and a second metal selected from Pd, Ni, Re, Ru, Ir, Sn, or a combination thereof as a Groups 7 to 10 and Group 14 metal in an amount of 0.01-5.0 wt. % or 0.01-2.0 wt. %, or 0.1-2.0 wt. %, more particularly 0.01-1.0 wt. % and 0.01-1.5 wt. %. In another instance, the catalyst comprises Pt as one of the modifying metals in an amount of 0.01-1.0 wt. % and 0.01-1.5 wt. % of the second metal selected from Groups 7 to 10 and Group 14, or, more particularly, 0.3-0.8 wt. % Pt and 0.05-0.5 wt. % of the second metal.

The metals content in the bimetallic SSZ-91 catalyst may be varied over typically useful ranges, e.g., the total modifying metals content for the catalyst may be 0.01-5.0 wt. % or 0.01-2.0 wt. %, or 0.1-2.0 wt. % (total catalyst weight basis). In some instances, the catalyst comprises 0.01-1.0 wt. % Pt as one of the modifying metals and 0.01-1.5 wt. % of a second metal selected from Groups 7 to 10 and Group 14, or 0.3-1.0 wt. % Pt and 0.03-1.0 wt. % second metal, or 0.3-1.0 wt. % Pt and 0.03-0.8 wt. % second metal. In some cases, the ratio of the first Group 10 metal to the optional second metal selected from Groups 7 to 10 and Group 14 may be in the range of 5:1 to 1:5, or 3:1 to 1:3, or 1:1 to 1:2, or 5:1 to 2:1, or 5:1 to 3:1, or 1:1 to 1:3, or 1:1 to 1:4.

The bimetallic SSZ-91 catalyst may further comprise a matrix material selected from alumina, silica, titania or a combination thereof. In specific more cases, the first catalyst comprises 0.01 to 5.0 wt. % of the modifying metal, 1 to 99 wt. % of the matrix material, and 0.1 to 99 wt. % of the SSZ-91 molecular sieve.

The hydrocarbon feed generally may be selected from a variety of base oil feedstocks, and advantageously comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof. The hydrocarbon feed may also comprise a feed hydrocarbon cut in the distillation range from 400-1300° F., or 500-1100° F., or 600-1050° F., and/or wherein the hydrocarbon feed has a KV100 (kinematic viscosity at 100° C.) range from about 3 to 30 cSt or about 3.5 to 15 cSt.

In some cases, the process may be used advantageously for a heavy neutral base oil as the hydrocarbon feed where the SSZ-91 catalyst includes a modifying metal combination selected from Pt/Pd, and Pt/Re.

The product(s), or product streams, may be used to produce one or more base oil products, e.g., to produce multiple grades having a KV100 in the range of about 2 to 30 cSt. Such base oil products may, in some cases, have a pour point of not more than about −5° C., or −12° C., or −14° C.

The process and system may also be combined with additional process steps, or system components, e.g., the feedstock may be further subjected to hydrotreating conditions with a hydrotreating catalyst prior to contacting the hydrocarbon feed with the SSZ-91 hydroisomerization catalyst, optionally, wherein the hydrotreating catalyst comprises a guard layer catalyst comprising a refractory inorganic oxide material containing about 0.1 to 1 wt. % Pt and about 0.2 to 1.5 wt. % Pd.

Among the advantages provided by the present process and catalyst system, are the reduction in aromatics content of the base oil product produced using the bimetallic SSZ-91 catalyst system, as compared with the same process wherein a non-bimetallic SSZ-91 catalyst is used. Among the benefits provided by the process and system, the aromatics conversion is notably increased by at least about 1.5 wt. % or 2.0 wt. %, or 3.0 wt. %, or 4.0 wt. %, or 5.0 wt. %, or 6.0 wt. %, when a bimetallic SSZ-91 catalyst is used, as compared with the use, in the same process, of a non-bimetallic SSZ-91 catalyst that only includes the same Group 10 metal, e.g., Pt, but not the second metal of the bimetallic SSZ-91 catalyst.

In practice, hydrodewaxing is used primarily for reducing the pour point and/or for reducing the cloud point of the base oil by removing wax from the base oil. Typically, dewaxing uses a catalytic process for processing the wax, with the dewaxer feed is generally upgraded prior to dewaxing to increase the viscosity index, to decrease the aromatic and heteroatom content, and to reduce the amount of low boiling components in the dewaxer feed. Some dewaxing catalysts accomplish the wax conversion reactions by cracking the waxy molecules to lower molecular weight molecules. Other dewaxing processes may convert the wax contained in the hydrocarbon feed to the process by wax isomerization, to produce isomerized molecules that have a lower pour point than the non-isomerized molecular counterparts. As used herein, isomerization encompasses a hydroisomerization process, for using hydrogen in the isomerization of the wax molecules under catalytic hydroisomerization conditions.

Suitable hydrodewaxing conditions generally depend on the feed used, the catalyst used, desired yield, and the desired properties of the base oil. Typical conditions include a temperature of from 500° F. to 775° F. (260° C. to 413° C.); a pressure of from 15 psig to 3000 psig (0.10 MPa to 20.68 MPa gauge); a LHSV of from 0.25 hr⁻¹ to 20 hr⁻¹; and a hydrogen to feed ratio of from 2000 SCF/bbl to 30,000 SCF/bbl (356 to 5340 m³ H₂/m³ feed). Generally, hydrogen will be separated from the product and recycled to the isomerization zone. Generally, dewaxing processes of the present invention are performed in the presence of hydrogen. Typically, the hydrogen to hydrocarbon ratio may be in a range from about 2000 to about 10,000 standard cubic feet H₂ per barrel hydrocarbon, and usually from about 2500 to about 5000 standard cubic feet H₂ per barrel hydrocarbon. The above conditions may apply to the hydrotreating conditions of the hydrotreating zone as well as to the hydroisomerization conditions of the first and second catalyst. Suitable dewaxing conditions and processes are described in, e.g., U.S. Pat. Nos. 5,135,638; 5,282,958; and 7,282,134.

The catalyst system generally includes a catalyst comprising a bimetallic SSZ-91 catalyst, arranged so that the feedstock contacts the SSZ-91 catalyst prior to further hydrofinishing steps. The bimetallic SSZ-91 catalyst may be by itself, in combination with other catalysts, and/or in a layered catalyst system. Additional treatment steps and catalysts may be included, e.g., as noted, hydrotreating catalyst(s)/steps, guard layers, and/or hydrofinishing catalyst(s)/steps.

### EXAMPLES

### Example 1—Hydroisomerization Catalyst Preparation

Hydroisomerization catalyst A was prepared as follows. Crystallite SSZ-91 was composited with alumina to provide a mixture containing 65 wt. % zeolite, and the mixture was extruded, dried, and calcined. The dried and calcined extrudate was impregnated with a solution containing platinum, and the impregnated catalyst was then dried and calcined. The overall platinum loading was 0.6 wt. %.

Hydroisomerization catalyst B was prepared as follows. Crystallite SSZ-91 was composited with alumina to provide a mixture containing 65 wt. % zeolite, and the mixture was extruded, dried, and calcined. The dried and calcined extrudate was impregnated with a solution containing palladium, and the impregnated catalyst was then dried and calcined. The metal loading was 0.46 wt. % Pd.

Hydroisomerization catalyst C was prepared as follows. Crystallite SSZ-91 was composited with alumina to provide a mixture containing 65 wt. % zeolite, and the mixture was extruded, dried, and calcined. The dried and calcined extrudate was impregnated with a solution containing platinum and palladium, and the co-impregnated catalyst was then dried and calcined. The metal loading was 0.67 wt. % Pt and 0.09 wt. % Pd.

Hydroisomerization catalyst D was prepared as follows. Crystallite SSZ-91 was composited with alumina to provide a mixture containing 65 wt. % zeolite, and the mixture was extruded, dried, and calcined. The dried and calcined extrudate was impregnated with a solution containing platinum and palladium, and the co-impregnated catalyst was then dried and calcined. The metal loading was 0.42 wt. % Pt and 0.23 wt. % Pd.

Hydroisomerization catalyst E was prepared as follows. Crystallite SSZ-91 was composited with alumina to provide a mixture containing 65 wt. % zeolite, and the mixture was extruded, dried, and calcined. The dried and calcined extrudate was impregnated with a solution containing platinum and Iridium, and the co-impregnated catalyst was then dried and calcined. The metal loading was 0.6 wt. % Pt and 0.2 wt. % Ir.

Hydroisomerization catalyst F was prepared as follows. Crystallite SSZ-91 was composited with alumina to provide a mixture containing 65 wt. % zeolite, and the mixture was extruded, dried, and calcined. The dried and calcined extrudate was first impregnated with a solution containing Rhenium, and the impregnated catalyst was then dried and calcined. The dried and calcined extrudate was impregnated the 2^{nd} time with a solution containing platinum, and the impregnated catalyst was then dried and calcined. The metal loading was 0.6 wt. % Pt and 0.2 wt. % Re.

Hydroisomerization catalyst G was prepared as follows. Crystallite SSZ-91 was composited with alumina to provide a mixture containing 65 wt. % zeolite, and the mixture was extruded, dried, and calcined. The dried and calcined extrudate was first impregnated with a solution containing ruthenium, and the impregnated catalyst was then dried and calcined. The dried and calcined extrudate was impregnated the 2^{nd} time with a solution containing platinum, and the impregnated catalyst was then dried and calcined. The metal loading was 0.6 wt. % Pt and 0.2 wt. % Ru.

Hydroisomerization catalyst H was prepared as follows. Crystallite SSZ-91 was composited with alumina to provide a mixture containing 65 wt. % zeolite, and the mixture was extruded, dried, and calcined. The dried and calcined extrudate was first impregnated with a solution containing tin, and the impregnated catalyst was then dried and calcined. The dried and calcined extrudate was impregnated the 2^{nd} time with a solution containing platinum, and the impregnated catalyst was then dried and calcined. The metal loading was 0.6 wt. % Pt and 0.4 wt. % Sn.

Hydroisomerization catalyst I was prepared as follows. Crystallite SSZ-91 was composited with alumina to provide a mixture containing 65 wt. % zeolite, and the mixture was extruded, dried, and calcined. The dried and calcined extrudate was first impregnated with a solution containing nickel, and the impregnated catalyst was then dried and calcined. The dried and calcined extrudate was impregnated the 2^{nd} time with a solution containing platinum, and the impregnated catalyst was then dried and calcined. The metal loading was 0.6 wt. % Pt and 0.2 wt. % Ni.

Table 1 summarizes the metals content of the bimetallic SSZ-91 catalysts used in the Examples. Catalysts A and B are non-bimetallic catalysts having only one modifying metal.

TABLE 1
Metals Content of the Bimetallic SSZ-91 Catalysts

| | Catalyst metals content, wt. % | | | | | | |
|---|---|---|---|---|---|---|---|
| Catalyst | Pt | Pd | Ir | Re | Ru | Sn | Ni |
| A | 0.6 | — | — | — | — | — | — |
| B | — | 0.46 | — | — | — | — | — |
| C | 0.67 | 0.09 | — | — | — | — | — |
| D | 0.42 | 0.23 | — | — | — | — | — |
| E | 0.6 | — | 0.2 | — | — | — | — |
| F | 0.6 | — | — | 0.2 | — | — | — |
| G | 0.6 | — | — | — | 0.2 | — | — |
| H | 0.6 | — | — | — | — | 0.4 | — |
| I | 0.6 | — | — | — | — | — | 0.2 |

### Example 2—Hydroisomerization Performance

The hydroisomerization performance of catalyst A through I of Example 1 was evaluated using feed and reaction conditions described in WO 2012/005980. A waxy heavy neutral hydrocracking product (hydrocrackate, 600N) feed was used having the characteristics shown in Table 2.

TABLE 2
Feed Properties

| Property | Value |
|---|---|
| API Gravity | 29.6 |
| N, ppm | 1 |
| S, ppm | 32 |
| Aromatics, Iv % | 18 |
| SIMDIST TBP (Wt. %), ° C. (º F.) | |
| 0.5 | 380 (716) |
| 5 | 431 (808) |
| 10 | 450 (842) |
| 30 | 487 (909) |
| 50 | 510 (950) |
| 70 | 532 (990) |
| 90 | 562 (1043) |
| 95 | 574 (1065) |
| 99.5 | 599 (1110) |

The reaction was performed in a micro unit and the run was operated under 1500-2300 psig total pressure (e.g., in some cases at 2100 psig total pressure) and a temperature in the range of 580-650° F. The catalysts were activated prior to the introduction of the feed. The heavy neutral feed was passed through the hydroisomerization reactor at an LHSV in the range of 0.5-3 hr⁻¹ and hydrogen to oil ratio of about 3000 scfb. The base oil unfinished product was separated from fuels through a distillation section. The aromatics content was determined by using the aromatics content in the dewaxed product. The conversion of aromatics was calculated by the following formula:

X=(C_{feed}−C_{product})/C_{feed}*100

where C_{feed} and C_{product} are the aromatics content in the feed and product. Results for the catalysts evaluated are shown in Table 3.

TABLE 3
Aromatics Conversions Obtained for Bimetallic Catalysts

| Catalyst | A | B | C | D | E | F | G | H | I |
|---|---|---|---|---|---|---|---|---|---|
| Aromatics | 86.9 | 93.8 | 93.5 | 93.8 | 84.0 | 88.9 | — | 86.7 | — |
| conversion, | | | | | | | | | |
| wt. % | | | | | | | | | |

Compared to reference catalyst A (Pt only), Examples C (Pt/Pd), D (Pt/Pd), and F (Pt/Re) showed significantly improved aromatics conversion, i.e., the quality of the base oil products made using these bimetallic catalysts is improved as compared with a non-bimetallic SSZ-91 catalyst that only included Pt as the modifying metal.

It will be understood that the invention is not limited to the embodiments described above and various modifications and improvements can be made without departing from the concepts described herein. Except where mutually exclusive, any of the features may be employed separately or in combination with any other features and the disclosure extends to and includes all combinations and sub-combinations of one or more features described herein.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1. A hydroisomerization process, useful to make dewaxed products including base oils, the process comprising
contacting a hydrocarbon feed with a hydroisomerization catalyst under hydroisomerization conditions to produce a product;
wherein, the hydroisomerization catalyst comprises an SSZ-91 molecular sieve and at least two different modifying metals selected from Groups 7 to 10 and Group 14 metals of the Periodic Table.

2. The process of claim 1, wherein the catalyst comprises a first Group 10 metal and a second metal selected from Groups 7 to 10 and Group 14 metals of the Periodic Table.

3. The process of claim 2, wherein the first Group 10 metal comprises Pt.

4. The process of claim 1, wherein the Groups 7 to 10 and Group 14 metal is selected from Pt, Pd, Ni, Re, Ru, Ir, and Sn.

5. The process of claim 2, wherein the second Groups 7 to 10 and Group 14 metal is selected from Pd, Ni, Re, Ru, Ir, and Sn.

6. The process of claim 1, wherein the sieve comprises ZSM-48 type zeolite material, the molecular sieve having:
at least 70% polytype 6 of the total ZSM-48-type material;
an EUO-type phase in an amount of between 0 and 3.5 percent by weight; and
polycrystalline aggregate morphology comprising crystallites having an average aspect ratio of between 1 and 8.

7. The process of claim 1, wherein the modifying metals content is 0.01-5.0 wt. % or 0.01-2.0 wt. %, or 0.1-2.0 wt. % (total catalyst weight basis).

8. The process of claim 1, wherein the catalyst comprises Pt as one of the modifying metals in an amount of 0.01-1.0 wt. % and 0.01-1.5 wt. % of the second metal selected from Groups 7 to 10 and Group 14, preferably 0.3-0.8 wt. % Pt and 0.05-0.5 wt. % second metal.

9. The process of claim 1, wherein the ratio of the first Group 10 metal to the second metal selected from Groups 7 to 10 and Group 14 is in the range of 5:1 to 1:5, or 3:1 to 1:3, or 1:1 to 1:2, or 5:1 to 2:1, or 5:1 to 3:1, or 1:1 to 1:3, or 1:1 to 1:4.

10. The process of claim 1, wherein the catalyst comprises Pt as a Group 10 metal in an amount of 0.01-1.0 wt. % or 0.3-0.8 wt. % and a second metal selected from Pd, Ni, Re, Ru, Ir, and Sn as a Groups 7 to 10 and Group 14 metal in an amount of 0.01-1.5 wt. %, or 0.05-0.5 wt. %.

11. The process of claim 1, wherein the silicon oxide to aluminum oxide mole ratio of the sieve is in the range of 40 to 220 or 50 to 220 or 40 to 200.

12. The process of claim 1, wherein the sieve comprises one of more of:
at least 80%, or 90%, polytype 6 of the total ZSM-48-type material;
between 0.1 and 2 wt. % EU-1;
crystallites having an average aspect ratio of between 1 and 5, or between 1 and 3;
or a combination thereof.

13. The process of claim 1, wherein the catalyst further comprises a matrix material selected from alumina, amorphous silica-alumina (ASA), or a combination thereof.

14. The process of claim 1, wherein the catalyst comprises 0.01 to 5.0 wt. % of the modifying metal, 1 to 99 wt. % of the matrix material, and 0.1 to 99 wt. % of the SSZ-91 molecular sieve.

15. The process of claim 1, wherein the hydrocarbon feed comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof.

16. (canceled)

17. A process for producing a base oil product having a reduced aromatics content, the process comprising subjecting a hydrocarbon feed to the process of claim 1.

18. The process of claim 17, wherein the hydrocarbon feed is a heavy neutral base oil and the catalyst comprises a modifying metal combination selected from Pt/Pd, and Pt/Re.

19. The process of claim 18, wherein the aromatics conversion is increased by at least about 1.5 wt. % or 2.0 wt. %, or 3.0 wt. %, or 4.0 wt. %, or 5.0 wt. %, or 6.0 wt. %, as compared with the use, in the same process, of an SSZ-91 catalyst that only contains Pt as the modifying metal.

20. A hydroisomerization catalyst for use in the process of claim 1, wherein the catalyst comprises an SSZ-91 molecular sieve and at least two different modifying metals selected from Groups 7 to 10 and Group 14 metals of the Periodic Table.

21. The catalyst of claim 20, wherein the catalyst comprises 0.01 to 5.0 wt. % of the modifying metals, 0.1 to 99 wt. % of the SSZ-91 molecular sieve, and 1 to 99 wt. % of a matrix material selected from alumina, amorphous silica-alumina (ASA), or a combination thereof
